(19) United States
(12) Patent Application Publication
(10) Pub. No.: US 2019/0070626 A1
(43) Pub. Date: Mar. 7, 2019

(54) Spraying Device Comprising a Piezoelectric Transducer Coupled to an Acoustic Concentrator, with Detection of the Internal Liquid Level

(71) Applicant: ARECO FINANCES ET TECHNOLOGIE - ARFITEC, Grasse (FR)

(72) Inventors: Michel GSCHWIND, Placassier (FR); Abbas SABRAOUI, Grasse (FR); Frédéric RICHARD, Vallauris (FR)

(21) Appl. No.: 15/777,778

(22) PCT Filed: Nov. 30, 2016
(86) PCT No.: PCT/FR2016/053138

§ 371 Date: Sep. 19, 2018

(30) Foreign Application Priority Data
Nov. 30, 2015 (FR) 1502493

(51) Int. Cl. B05B 17/06; B05B 12/08

(52) U.S. Cl. CPC B05B 17/0615; B05B 17/0676; B05B 17/0669; B05B 12/081

(57) ABSTRACT

Spraying devices capable of producing a fog of micro-droplets from a liquid, and which includes detection of the level of the liquid to be sprayed. The micro-droplets are generated by a piezoelectric element coupled to an acoustic concentrator.

### CROSS-REFERENCE TO RELATED APPLICATIONS

The present application is a National Stage Application of PCT International Application No. PCT/FR2016/053138 (filed on Nov. 30, 2016), under 35 U.S.C. § 371, which claims priority to French Patent Application No. 1502493 (filed on Nov. 30, 2015), which are each hereby incorporated by reference in their respective entireties.

### TECHNICAL FIELD

Embodiments of the invention relate to the technical field of spraying devices capable of producing a fog of micro-droplets from a liquid. The droplets are generated by a piezoelectric element coupled to an acoustic concentrator. More precisely, embodiments of the invention relate to such a device comprising a detection of the level of the liquid to be sprayed.

### BACKGROUND

Spraying devices capable of producing a fog of micro-droplets from a liquid by piezoelectric excitation are known per se. In these systems, the piezoelectric element can be associated with a microperforated membrane or with an acoustic concentrator in order to favor the production of fog.

In systems having a microperforated membrane, the piezoelectric transducer is coupled to a microperforated membrane, which is in contact with the liquid to be sprayed. These systems are described for example in documents WO 2013/110248 (Nebu Tec), WO 2012/020262 and WO 05/15822 (Technology Partnership), EP 2 244 314 (Zobele Holding), US 2006/213503 and US 2005/224076 (Pari Pharma), WO 2001/85240 (Pezzopane), FR 2 929 861 (L'Oréal), U.S. Pat. No. 8,870,090 (Aptar), WO 2008/058941 (Telemaq), JP 2001/300375 (Panasonic). These systems are simple and compact, but, as a general rule, their flow rate is very low, i.e., they produce a very low quantity of fog. Their useful life is rather limited (often less than 1,000 hours). They can be suitable for certain uses (for example for diffusing perfumes in a room), but not for others. Moreover, these devices require careful maintenance as the membrane risks becoming clogged. These systems are also relatively sensitive to the water pressure above the membrane and to the air pressure in the diffusion volume; problems of water leaking can appear. This lack of robustness of devices that use a perforated membrane can limit their interest for certain types of applications, in particular, industrial and especially products intended for the general public (refrigerator, electric wine cellar), which requires a substantial useful life (of about 5 to 10 years) and for which complex and frequent maintenance procedures cannot be considered.

In systems having an acoustic concentrator, the piezoelectric transducer is coupled directly to the liquid to be sprayed, with which it is in contact. More precisely, these systems, as a general rule, use a tank provided with a concentration nozzle and with a piezoelectric element, as described for example in documents EP 0 691 162 A1 and EP 0 782 885 A1 (IMRA Europe). These devices are very reliable and are commonly used to wet and to cool fresh products on sales counters, as described in documents FR 2 899 135 A1, FR 2 921 551 A1, WO 2014/023907 A1, WO 2013/034847 A1 (ARECO), FR 2 690 510 A1 (Techsonic). The flow rate is high and is suitable for many technical and industrial uses. As they do not comprise perforated membranes, these devices do not risk being disturbed in their operation by clogging problems; they have a useful life of 5,000 hours on the average. On the other hand, these devices have a significant size which is primarily linked to the thickness of water required for the correct operation of the piezoelectric element (generally from 20 to 35 mm), and also, at the height of the diffusion chamber required for the creation of an acoustic stream that is almost vertical and very powerful (generally from 40 to 100 mm).

There are devices of which the “water flow rate/electrical power” output has been optimized. These systems are generally provided with nozzles acting as concentrators of the acoustic waves generated by the piezoelectric element working at a very high frequency (of about a few MHz), a water circulation pump, a fan and a specific electrical power supply. The integration of all of these elements into a reduced volume remains a blocking point for many applications which require a system with high performance (flow rate/electrical power ratio) and very high reliability (especially the piezoelectric element, the fan, the pump, high-frequency generators, the level sensor, the filling solenoid valves).

In a misting system having piezoelectric excitation it is always necessary to monitor the presence and the volume of water in front of the piezoelectric transducer, for the following two reasons:

On the one hand, the transducer has to be protected from a lack of water, which can lead to the destruction of the piezoelectric element, especially in the cases of high electrical power absorbed. Indeed, gases (such as air) have an acoustic impedance that is much more substantial for the acoustic waves than liquids (such as water). If the piezoelectric ceramic is not covered with a liquid, the acoustic energy is therefore dissipated in the piezoelectric ceramic itself, leading to the heating thereof. If this heating is substantial or prolonged, this can lead to the degradation, and even the functional destruction of the piezoelectric element.

Good stability of the misting density over time must also be guaranteed; this aspect is particularly important in applications that require a very precise and controlled level of humidity.

The lack of water can be momentaneous, for example, when the level of water of the system moves following the permanent or occasional movement of the system; this problem can arise for misting systems on board vehicles. The lack of water can also be linked to the lack of supply with water. The resupplying with water can be automatic or manual. However, it is known that the flow rate of the fog generated by the system depends, for an equal dissipated power, on the level of water above the piezoelectric element.

In order to respond to these problems, most misting systems having piezoelectric excitation are provided with a water level sensor. These sensors can be of the optical, capacitive, ultrasound, electromechanical, magnetic, etc. type. They typically have a problem of congestion, precision, price and reliability. More precisely: the congestion of the sensor can become a problem in miniaturized systems. The precision must become a problem because many level sensors have a low trigger point and a high trigger point. The price can become a problem in the case of miniaturized systems which open new applications with the condition of being inexpensive. The reliability can become a problem due to the inevitable clogging of the active surface of the sensor.

The problem that this invention seeks to resolve is to present a misting system having improved piezoelectric excitation, which has better reliability, allows for a more compact construction, less expensive, and a better adjustment precision, and which lends itself, in particular, to miniaturized systems.

### SUMMARY

To this effect, embodiments of the invention have for object a misting device having piezoelectric excitation, comprising:
a tank able to contain a liquid,
a piezoelectric element arranged at least partially in the inner volume of the tank, with this element having an active surface capable of transmitting acoustic waves in the liquid, when this active surface is at least partially covered with liquid, for the purpose of misting this liquid,

this device being characterized in that it further comprises:
measurement means able to measure a parameter representative of the current consumed by the piezoelectric element;
alert means, capable of being activated in response to said measurement means, when the instantaneous value of said representative parameter lies outside a predefined range.

According to other characteristics of this misting device, taken separately or according to any technically compatible combination:
the device further comprises first control means, capable of activating liquid inlet means in the tank, in response to said alert means;
the device further comprises second control means, capable of activating the means for stopping the piezoelectric element, in response to said alert means;
the device further comprises at least one alert member, capable of transmitting at least one signal that can be perceived by a user, in response to said alert means;
the means for supplying with liquid comprise a solenoid valve;
the active surface of the piezoelectric element is inclined with respect to the horizontal according to an angle between 45° and 135°, in particular, according to an angle of 90°;
the parameters representative of the current consumed by the piezoelectric element is the current consumed by the piezoelectric element.

Embodiments of the invention also have for an object, a method for implementing a listing device such as defined hereinabove, comprising:
a liquid tank,
a piezoelectric element arranged at least partially in the inner volume of the tank, with this element having an active surface capable of transmitting acoustic waves in the liquid for the purpose of misting this liquid;
measurement means able to measure a parameter representative of the current consumed by the piezoelectric element;
alert means, capable of being activated in response to said measurement means, when the instantaneous value of said representative parameter lies outside a predefined range;

this method comprising the following steps:
a parameter representative of the current consumed by the piezoelectric element is measured;
the alert means are activated when the instantaneous value of said representative parameter lies outside a predefined range.

According to other characteristics of this method, taken separately or according to any technically compatible combination:
the first control means are activated, in such a way as to cause an inlet of liquid in the tank, when the instantaneous value of said representative parameter reaches a first predetermined value, referred to as the high threshold value;
a first type of signal is transmitted thanks to the alert member, when the instantaneous value of said representative parameter reaches a first predetermined value, referred to as the high threshold value;
the first predetermined value is determined according to a value referred to as optimal of said parameter, corresponding to an implementation of the device wherein the active surface is entirely covered with liquid;
the first predetermined value is between 110% and 120% of the optimum value;
the method further comprises a step of calibration, wherein the variation in the current consumed is determined according to the voltage at the terminals of the piezoelectric element in a state referred to as optimal of the device, for which the active surface is entirely covered with liquid, as well as in a state referred to as intermediate of the device, for which the active surface is partially covered with liquid;
the second control means are activated, in such a way as to cause the stopping of the piezoelectric element, when the instantaneous value of said representative parameter reaches a second predetermined value, referred to as the low threshold value;
a second type of signal is transmitted, different from said first type of signal, when the instantaneous value of said representative parameter reaches a second predetermined value, referred to as the low threshold value;
the method further comprises another step of calibration, wherein the variation in the current consumed is determined according to the voltage at the terminals of the piezoelectric element is a so-called critical state of the device, for which the active surface is not at all covered with liquid;
the parameter representative of the current consumed by the piezoelectric element is the current consumed by the piezoelectric element.

The inventors have found that the problem posed can be resolved surprisingly without having recourse to a liquid level sensor, by using the piezoelectric element itself as a means for detecting the liquid. Indeed, the inventors have observed a link between the characteristics of the misting stream and the current consumption of the piezoelectric element.

According to embodiments of the invention, a parameter representative of the current consumed by the piezoelectric element is measured. This parameter can be the consumed current itself. As an alternative, this can be a magnitude, such as the voltage, from which those skilled in the art can access the current consumed.

### DRAWINGS

FIGS. 1 to 8 show embodiments of the invention, but do not limit the scope of embodiments of the invention.

FIG. 1 is a diagrammatical view, showing a misting device in accordance with embodiments of the invention, of which the container is entirely filled with liquid;

FIG. 2 is a diagrammatical view, similar to FIG. 1, wherein the liquid has an intermediate filling level in the container;

FIG. 3 is a diagrammatical view, similar to FIG. 1, wherein the container is devoid of liquid;

FIG. 4 is a graph, showing the variations in the current consumed by the piezoelectric element belonging to the device in accordance with embodiments of the invention, according to the voltage applied to the terminals of this element, for each one of the, three levels of liquid of FIGS. 1 to 3;

FIG. 5 is a diagrammatical view, showing certain control members of the piezoelectric element belonging to the device in accordance with embodiments of the invention;

FIG. 6 is a diagrammatical view, showing in more detail some of the other control members of the piezoelectric element;

FIG. 7 is an electronic diagram of the misting device in accordance with embodiments of the invention;

FIG. 8 is a graph, showing the variation in the current consumed by the piezoelectric element, according to the level of filling of the container.

### DESCRIPTION

FIG. 1 shows the system 1 according to embodiments of the invention in the situation of normal operation, i.e., with a level of liquid said to be suitable or optimal Iopt. The system 1 comprises a tank 10, forming a container, a piezoelectric element 20, and an acoustic concentrator 30. The piezoelectric element 20 generally has the form of a wafer with a circular shape. In the example of FIG. 1, the piezoelectric element 20 is arranged vertically, with its active surface (here also called “transmitting face”) 21 being oriented in the direction of the acoustic concentrator 30. Note as a the angle formed by the horizontal and the main direction of the active surface mentioned hereinabove. In the example shown, this angle has a value of 90°. However, embodiments of the invention have applications at other values of this angle, generally at any non-horizontal piezoelectric element, namely for which the angle α is different from 0° and from 180°. Typically, this angle α is between 45° and 135°, it can for example be between 70 and 110°.

The piezoelectric element 20 generates ultrasound waves 40 which are transmitted in the direction of the acoustic concentrator 30. The acoustic concentrator 30 can have a parabolic or other shape; the focal point of the acoustic concentrator 30 here bears the reference 50. The acoustic concentrator 30 is advantageously made from a hard material (for example, metal) that can reflect ultrasound waves. The frequency of the ultrasounds used in the framework of this invention lies advantageously between 1.3 MHz and 3 MHz, it can be for example 1.68 MHz.

In normal operation of the system 1, the active surface 21 of the piezoelectric element 20 is entirely covered with liquid and the ultrasound waves 40 are transmitted in the liquid where they impact against the surface of the acoustic concentrator 30. The acoustic concentrator 30 is designed in such a way, and the liquid level is adjusted in such a way, that the focal point 50 of the ultrasound waves 40 lies slightly below the liquid level Iopt. This provides a stable misting stream 70 and a maximum generation of fog 60. In the case of FIG. 1, the operation of the system 1 is optimal. The current consumption of the piezoelectric element 20 is stable and varies linearly according to the voltage applied. In a functional case given here as an example, the voltage applied to the excitation board is 12 volts (V), the current required corresponds to 400 milliamps (mA).

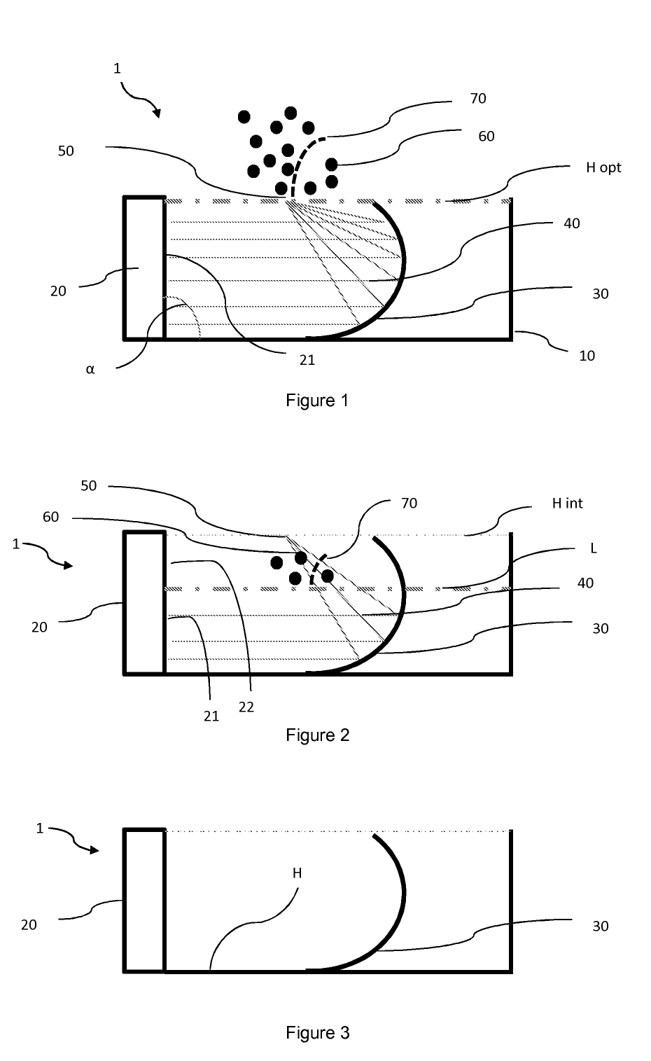

FIG. 2 shows the same system as FIG. 1, but with a liquid level Iint, referred to as intermediate, which is abnormally low: the liquid no longer covers all the active surface 21 of the piezoelectric element 20. This has two consequences: firstly, knowing that the focal point 50 of the acoustic waves 40 now lies above the intermediate liquid level Iint, the waves generate a stream of liquid 70, but little fog 60. In addition, in light of the fact that the acoustic impedance of air is much higher than that of liquid, the non-submerged portion 22 of the active surface 21 only transmits a negligible portion of the electrical power absorbed in the form of ultrasound: the rest is reflected on the surface of the non-submerged portion 22 and dissipated as heat.

The inventors have observed that this heating modifies the electrical consumption of the piezoelectric element 20, as shall be detailed in reference to FIG. 8. More precisely, this heating modifies the current absorbed; this difference amounts to a few percent, but it is sufficient to be detected.

Typically, in a misting system having piezoelectric excitation, the piezoelectric element 20 is powered by pulse trains at a fixed voltage, with these pulses being close to the resonance frequency of the piezoelectric element 20. When the current absorbed by the piezoelectric element 20 is measured, it is observed that this current increases with the temperature. By way of example, in a misting system having piezoelectric excitation, the piezoelectric element was powered with a voltage of 12 volts and the current absorbed was 400 mA in normal operation; this current is 440 mA when a portion of the active surface of the piezoelectric element is not submerged.

Surprisingly, the inventors have observed that when the non-submerged portion of the active surface of the piezoelectric element 20 increases, the current absorbed decreases and changes to a value close to zero in the total absence of liquid (FIG. 3). The piezoelectric element 20 cannot transmit in air as in liquid, its impedance is therefore limited and its current consumption is much less than that Iopt in optimum regime as well as that Iint in intermediate regime.

FIG. 8 summarizes the variation of the current consumed I according to the height H of liquid in the tank. More precisely, the percentage of the height of the active surface, covered by the liquid, is shown on the abscissa. The value 0 corresponds to an empty tank (FIG. 3), the value 100 corresponds to the liquid covering all of the active surface (FIG. 1), the value 50 corresponds to the liquid covering half of the height of the active surface (FIG. 2).

When the liquid covers the entire height of the surface, the consumed current has a value referred to as optimal Iopt, which can also be found when the liquid is present in excess (right portion of the curve corresponding to the values 110 and 120). When the liquid level decreases, the value of the current consumed increases slightly, from the optimum value Iopt hereinabove to a value referred to as intermediate Iint. This value of consumed current is then substantially constant as the liquid level drops, until dropping substantially to a value referred to as critical Icrit which corresponds to an empty liquid tank.

There are therefore three characteristic values of consumed current according to the water level, which correspond to three states of the device: optimal when the liquid level is satisfactory, intermediate when the liquid level is insufficient but the integrity of the piezoelectric element is not called into question, and finally critical when there is no longer any liquid in the tank. Typically, Iint is slightly greater than Iopt, by 10 to 20%, while Icrit is much less than Iopt.

In all of these embodiments of this invention said liquid can be water, possibly comprising substances (ionic or non-ionic) in solution or in dispersion. For example, the water can include one or several organic products, miscible or not, such as an alcohol or an essential oil.

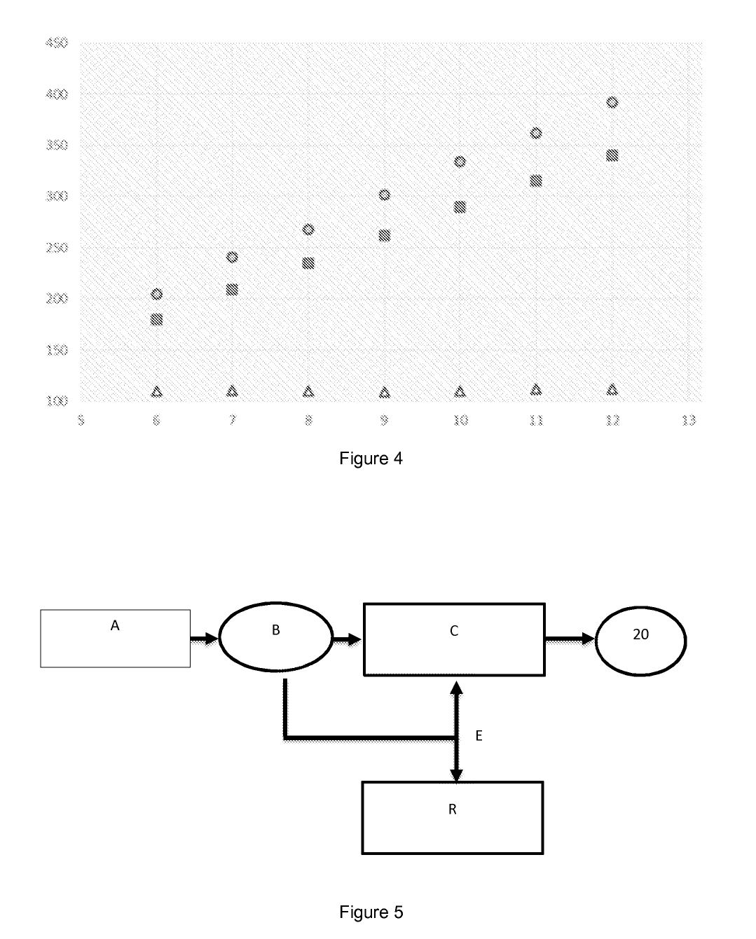

FIG. 4 shows the response diagram of the current consumption by the piezoelectric element 20 according to the operating modes described hereinabove. Each one of the curves comprises several samples of values of consumed current (on the ordinates) according to the various voltages applied to the piezoelectric element (on the abscissa). Each curve represents an operating mode presented as follows:
The curve formed of squares corresponds to an optimum operation of the piezoelectric element. This optimum operation corresponds to FIG. 1 when the system comprises the height defined hereinabove Iopt of liquid entirely covering the piezoelectric element 20.
The curve formed of circles corresponds to an intermediate operation of the piezoelectric element 20. This intermediate operation corresponds to FIG. 2 when the system comprises the height Iint of liquid defined hereinabove.
The curve formed of triangles corresponds to an operation when empty as described hereinabove in reference to FIG. 3.

Each one of the curves, representing an operation mode, shows the linearity between the voltage applied to the terminals of the piezoelectric element 20 and the consumed current. It follows that this variation in the current consumption according to the liquid level cannot be used directly to detect the liquid level: a calibration must be carried out.

FIG. 5 diagrammatically shows a method of regulation that is based on the measurement of the current and on the voltage of the piezoelectric element in order to detect the presence or the absence of water and of misting.

In the case of a high-power electronic circuit where a signal generator supplies the piezoelectric element at a fixed frequency it is observed that the current at the supply of the circuit varies according to the surface fraction of the active surface of the piezoelectric element that is covered with water.

In a typical embodiment, the piezoelectric element is powered with direct current (for example with a voltage of 24V DC), modulated by the resonance frequency of the piezoelectric element. In such a normal operating mode, the active surface of the piezoelectric element is entirely covered with liquid; the misting operates, and the current consumption is stable (typically at about 2.3 A for a diameter of the active surface between about 10 mm and about 20 mm).

In the case where the active surface of the piezoelectric element is only partially covered with liquid, the inventors have observed a drop in the current which is significant and extremely fast (in less than 100 ms). This drop can be about 30 to 40% of the nominal value of the current absorbed by the piezoelectric element entirely covered with liquid (in the example about 2.3 A). These indicators make it possible to react quickly in order to cut off the power supply of the piezoelectric element or to decrease the electric power supplied by said power supply to the piezoelectric element, and/or to trigger another filling with water. As such it is possible to return to an operating mode in which the active surface is completely submerged.

This indicator, which is connected to the drop in current observed, can be correlated with a temporal measurement in order to estimate the rate of misting of our system and to possibly trigger alarms in the case of a problem due to the filling or to the correct operation of the piezoelectric element.

An illustration of such a method for regulation is described here. The first three steps are typically implemented during the first use of the device. Indeed, the characteristics intrinsic to the various piezoelectric elements can vary from one device to the other. These steps make it possible to access the knowledge of these characteristic.

1st Step: Calibration of the Parameters in the Optimal Presence of the Liquid.

The voltage A is made to vary by a minimum service value to a maximum service value (for example from 6V to 12V), the value of the current B for each voltage is measured and recorded. These values will be used as a reference to detect the variation of the current during the misting and to indicate to the users the presence of the absence of water.

2nd Step: Calibration of the Parameters in the Intermediate Presence of the Liquid.

The voltage A is made to vary between the minimum and maximum service values hereinabove, the value of the current B for each voltage is measured and recorded. These values will be used as a reference to detect the variation of the current during misting and to indicate to the users the presence or the absence of water.

3rd Step: Calibration of the Parameters in the Absence of Liquid.

The voltage A is made to vary between the minimum and maximum service values hereinabove, the value of the current B for each voltage is measured and recorded. These values will be used as a reference to detect the variation of the current during misting and to indicate to the users the presence or the absence of water.

4th Step: Configuration of the System

The various values of consumed current for each voltage observed are recorded in the control means of the piezoelectric C. As such, pour each value of voltage at which the device can be put into service, in particular the values Iopt, Iint and Icrit are recorded such as defined hereinabove.

In the example indicated hereinabove (self-oscillating circuit), when it is powered with 12 Volts, the consumption Iopt of the piezoelectric element is 400 mA for a normal operation. This consumption increases to a value Iint in the neighborhood of 440 mA in operation with a low liquid level, then this current consumption falls to a value Icrit in the neighborhood of 110 mA in the absence of liquid as shown in FIG. 3

5th Step: Normal Operation.

The value of the current consumed by the piezoelectric element is measured. This measurement can be continuous or, alternatively, it is possible to take regular measurements at a suitable frequency. As long as the instantaneous value of this current I does not reach the threshold value such as shown in FIG. 8, there is no retroaction. In other terms, it is not necessary to add liquid in the tank.

6th Step: Supplying with Water

The regulation system C makes it possible to control the solenoid valve E providing the filling of the tray R when the current consumption of the piezoelectric 20 becomes excessive. More precisely, when the measured instantaneous value of current consumed reaches the threshold value Iint defined hereinabove, the regulation system triggers an alert which is directed towards the solenoid valve E. The latter then controls the inlet of additional liquid into the tank, which has for effect to lower the value of the current consumed. The device returns to an optimum configuration, such as defined hereinabove, in such a way that the inlet of water is then stopped.

As an alternative, the alert triggered by the regulation system may not be transmitted to a solenoid valve, but to a signaling member. The latter then transmits a signal that can be perceived by the user, in particular of the visual and/or audible type. The adding of liquid into the tank is, in this case, directly provided by the user, not by a mechanical element of the device.

7th Step: Notification of a Lack of Water and Stoppage

The regulation system C is able to stop the piezoelectric in order to limit breakage of the latter when it detects a low consumption of current by the piezoelectric element 20.

More precisely, when the measured instantaneous value of current consumed reaches the threshold value I Icrit defined hereinabove, the regulation system triggers an alert which is directed towards the means for automatically cutting off the piezoelectric element. This makes it possible to guarantee the mechanical integrity of this element, which would be placed in danger if this situation of absence of water were to be prolonged.

As an alternative, the alert triggered by the regulation system may not be transmitted to means for cut-off, but to a signaling member. The latter then transmits a signal that can be perceived by the user, in particular of the visual and/or audible type. The stoppage of the piezoelectric element is, in this case, directly provided by the user, not by a mechanical element of the device.

As described hereinabove, in the sixth and seventh steps, both the need for a supply with water and the need to cut off the piezoelectric element can be reported directly to the user. In this case, two different signals are advantageously provided, respectively for the need for water and the stoppage of the piezoelectric element. It is possible to use two different signaling members or, as an alternative, a single member able to transmit two different signals.

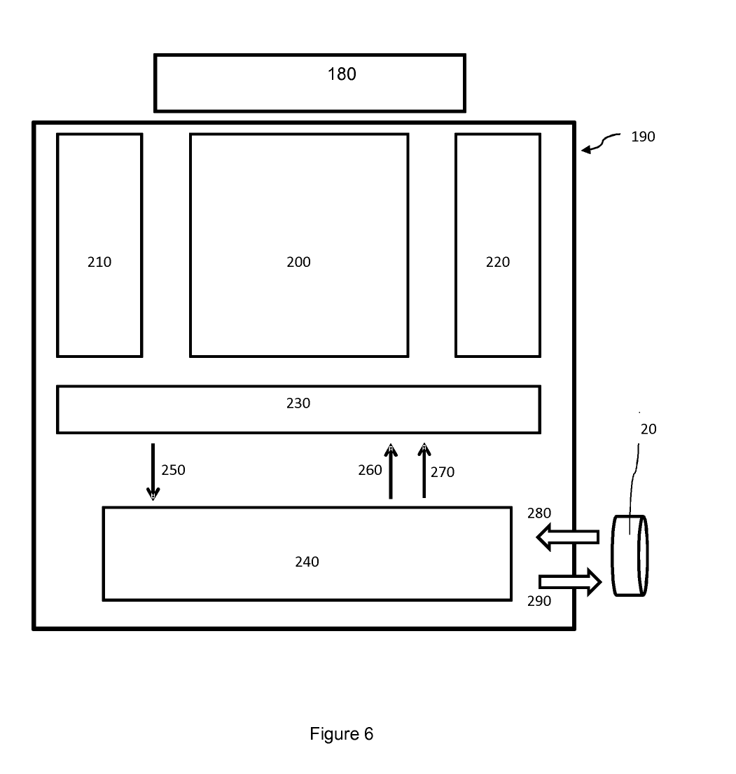

FIG. 6 implements an electronic assembly. The controlling of the assembly is carried out by a board 190 of which the power supply is done in an offset manner by a module 180 of power supply. The direct voltage supplied can be between 6 and 40 Volts.

This board is constructed around the microcontroller 200 allowing for the application management of the steps mentioned hereinabove. This microcontroller 200 also manages the connectivity of the input/output modules.

This board comprises an all-or-nothing (AON) analog input module 210 and an output module 220. These assemblies make it possible to control the supply of water of the container in case of an intermediate or empty level or to control the information signal that makes it possible to inform the user of the need to fill the tank that supplies the container.

A subassembly 230 is present to form the piezoelectric control 25, this makes it possible to define the excitation frequency, the voltage, the duty cycle. This module also makes it possible to obtain the information on the current consumed 260 as well as the temperature 270 of the piezoelectric 20.

The last module 240 of this board 190 is the checking and control element of the piezoelectric. This module is the interface allowing for the sending of the voltage signal that makes it possible to excite the piezoelectric 20 and in return to obtain the temperature of said element 20.

### EXAMPLE

Embodiments of the invention is shown hereinbelow via examples that however do not limit the scope thereof. This example concerns an implementation of the power control module of the piezoelectric.

In order to carry out the method of regulation, those skilled in the art need to understand the technical aspect linked to the module 240 of FIG. 6.

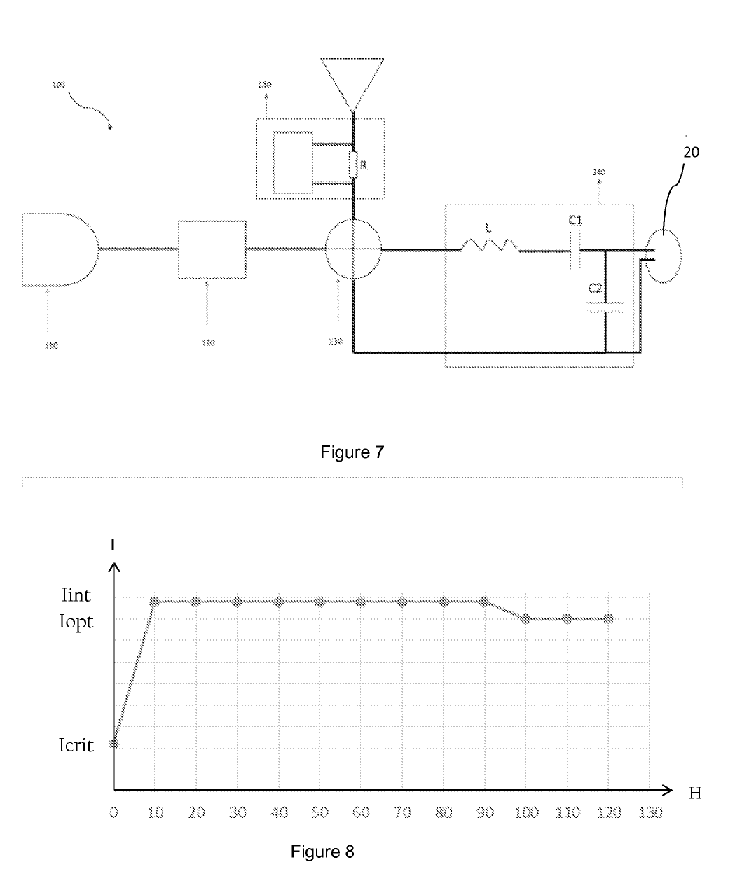

In FIG. 7, the board 100 is constructed around the microcontroller, which has for role to manage the signal generator and afterwards the control of the piezoelectric. The board 100 also has a 12V switching regulator for the controlling of the transistor via the driver (120), and a 5V linear regulator for the adaptation of the input control signal.

The principle of the driver (120) is to be able to supply for a short instant the substantial current required for the switching of the transistor 130 to high frequencies. During the control signal edges, the inrush current of the control of the transistor 130 is very high, and providing enough current allows for a fast switching, which limits the transient states that cause a heating of the transistor 130.

In order to be able to rapidly supply a substantial current, the transistor driver 120 uses several capacitors in parallel upstream of the component. The control voltage of the transistor is set to 12V, as such minimizing the effect of its Ron characteristic and therefore the heating of the component.

The excitation frequency of the piezoelectric 20 is generated by the component 110, which produces a square signal with a programmable frequency (by default 1.7 MHz). The circuit for adapting the impedance 140 of the piezoelectric 20 is comprised of a coil and a capacitor in series with a capacitor in parallel on the output.

The relation between the values of these components (L and C) is a very important factor in the behavior of an LC circuit and are chosen taking account of the impedance of the piezoelectric element (in water) and of its resonance frequency, and which will fix in what follows its average current consumption.

The resultant is a stable and constant sinusoidal signal according to time at the terminals of the piezoelectric element adapted to an optimum operation in water. (The values of the peak-to-peak voltages/current must not exceed the max limit of the piezoelectric element).

$$f 0 = \frac{1}{2 π \sqrt{LC}}$$

f0: the resonance frequency.

L: the value of the coil.

C: the value of the capacitor.

For an operation without water, the value of the impedance of the piezoelectric element will change and introduce an electrical impedance mismatch for all of the circuit and will change in what follows its current consumption.

The piezoelectric 20 is controlled by a transistor 130, that has an excellent command load ratio and resistance at the off state, and a very fast response time that allows it to operate at a high frequency (1.7 MHz), that makes it possible to have both a quality signal and moderate heating.

In order to provide the fastest switching possible and therefore to limit the heating of the transistor, which is very substantial during the transition phases, a control driver 120 that can deliver up to 2×5 A is placed upstream.

The current measurements 150 are taken using a shunt resistor with a low value, between 0.01 and 0.1 ohm according to the current consumed, and a component of the voltmeter type measuring the difference in potential at the terminals of the resistor and multiplying by 10 the result in order to have a value that is more legible for the microcontroller.

The microcontroller in what follows will compare the values of current taken in order to define the operating state of the piezoelectric. This state will make it possible to validate the step of the method.

### LISTING OF REFERENCE SYMBOLS

The following numerical references are used in this description:
1 System according to embodiments of the invention
10 Tank
20 Piezoelectric element
21 Active surface of piezoelectric element
22 Non-submerged portion of piezoelectric element
30 Acoustic concentrator
40 Acoustic waves
50 Focal point of acoustic concentrator
60 Fog
70 Stream of liquid
Iopt Optimum height
Hint Intermediate height
A Angle of active surface of piezoelectric element
Iopt Intensity of optimum current
Iint Intensity of intermediate current
Icrit Intensity of critical current
C Regulation system
E Solenoid valve
100 Board
120 Driver
130 Transistor
140 Adaptation circuit
180 Supply module
190 Electronic board
200 Microcontroller
210 Input module
220 Output module
230 Subassembly
240 Module of electronic board
250 Control element of acoustic waves
260 Information on the current
270 Information on the temperature

1-16. (canceled)

17. A misting device, comprising:
a liquid tank defining an inner volume;
a piezoelectric element arranged at least partially in the inner volume of the tank, the piezoelectric element having an active surface such that, when the active surface is at least partially covered with liquid, is configured to transmit acoustic waves in the liquid to facilitate misting of the liquid;
measurement means configured to measure a parameter representative of current consumed by the piezoelectric element; and
alert means configured for activation in response to a measurement by said measurement means, when an instantaneous value of said representative parameter lies outside a predefined range.

18. The misting device of claim 17, further comprising:
liquid inlet means for the liquid tank; and
first control means configured to activate the liquid inlet means in response to said alert means.

19. The misting device of claim 18, further comprising:
means for stopping the piezoelectric element; and
second control means configured to activate the means for stopping the piezoelectric element, in response to said alert means.

20. The misting device of claim 17, further comprising at least one alert member configured to transmit at least one signal to be perceived by a user, in response to said alert means.

21. The misting device of claim 17, further comprising means for supplying liquid to the container, the means for supplying liquid comprising a solenoid valve.

22. The misting device of claim 17, wherein the active surface of the piezoelectric element is inclined a predetermined angle with respect to the horizontal, the predetermined angle being between 45° and 135°.

23. The misting device of claim 22, wherein the predetermined angle is 90°.

24. A method for creating a mist from a liquid, the method comprising:
providing a liquid tank defining an inner volume, measurement means, alert means, and a piezoelectric element arranged at least partially in the inner volume of the tank, the piezoelectric element having an active surface;
covering with liquid, at least partially, the active surface of the piezoelectric element so as to transmit, via the piezoelectric element, acoustic waves in the liquid to facilitate misting of the liquid;
measuring, via the measurement means, a parameter representative of the current consumed by the piezoelectric element;
activating the alert means when an instantaneous value of said representative parameter lies outside a predefined range.

25. The method of claim 24, further comprising activating, when the instantaneous value reaches a first predetermined value, a first control means to cause an inlet of liquid in the tank.

26. The method of claim 24, further comprising transmitting a first type of signal via the alert member, when the instantaneous value reaches a first predetermined value.

27. The method of claim 26, further comprising determining the first predetermined value is determined according to an optimal value of said parameter, when the active surface is entirely covered with liquid.

28. The method of claim 27, wherein said first predetermined value is between 110% and 120% of the optimum value.

29. The method of claim 24, further comprising:
calibrating the measurement means; and
determining a variation in the current consumed by the piezoelectric element according to the voltage at terminals of the piezoelectric element, for which the active surface is not at all covered with liquid.

30. The method of claim 24, further comprising activating a second control means to cause the stopping of the piezoelectric element, when the instantaneous value reaches a second predetermined value.

31. The method of claim 24, wherein said parameter representative of the current consumed by the piezoelectric element comprises the current consumed by the piezoelectric element.

32. The method of claim 24, wherein said liquid comprises water, possibly comprising substances in solution or dispersion, and in particular one or several organic products, miscible or not.

33. The method of claim 32, wherein said water includes substances in solution or dispersion.

34. The method of claim 32, wherein said water includes one or several organic products.

35. The method of claim 24, further comprising adjusting the liquid level so that a focal point of the ultrasound lies below the liquid level.
